(19) United States
(12) Patent Application Publication
(10) Pub. No.: US 2019/0005146 A1
(43) Pub. Date: Jan. 3, 2019

(54) Manipulating Virtual Camera Dolly in Multi-Dimensional Space to Produce Visual Effect

(71) Applicant: Famous Industries, Inc., San Francisco, CA (US)

(72) Inventors: Mark H. Lu, San Francisco, CA (US); Steven E. Newcomb, San Francisco, CA (US); Brian R. Maissey, Berkeley, CA (US); Andrew J.L. de Andrade, San Francisco, CA (US)

(21) Appl. No.: 15/927,823

(22) Filed: Mar. 21, 2018

Related U.S. Application Data
(63) Continuation of application No. 14/534,159, filed on Nov. 5, 2014, now abandoned.
Application No. 14/534,159 is a continuation-in-part of application No. 14/054,570, filed on Oct. 15, 2013.
(60) Provisional application No. 61/714,130, filed on Oct. 15, 2012.

(51) Int. Cl. G06F 17/30; G06F 3/0481

(52) U.S. Cl. CPC G06F 17/30893; G06F 3/04815

(57) ABSTRACT

Various implementations for manipulating a virtual camera dolly in a multi-dimensional space to produce a visual effect are described. Content is rendered for display via a viewport. The viewport displays a virtual multi-dimensional space. A content movement input is received. A visual effect is determined to apply to the content based on the content movement input and a position of the content relative to a boundary associated with an anchor position in the multi-dimensional space. A virtual camera dolly is manipulated to produce the visual effect. The virtual camera dolly represents a viewing perspective for viewing the content via the viewport in the multi-dimensional space.

### CROSS-REFERENCE TO RELATED APPLICATIONS

This application is a continuation of U.S. patent application Ser. No. 14/534,159, entitled “Manipulating Virtual Camera Dolly in Multi-Dimensional Space to Product Visual Effect,” filed Nov. 5, 2014, which is a continuation-in-part of U.S. patent application Ser. No. 14/054,570, entitled “Efficient Manipulation of Surfaces in Multi-Dimensional Space Using Energy Agents” filed Oct. 15, 2013, which claims the benefit under 35 U.S.C. § 119(e) of U.S. Provisional Patent Application No. 61/714,130, entitled “User Input Conversion System Using Vector Agents for Rendering Images” filed Oct. 15, 2012, the entire contents of each of which are incorporated herein by reference.

### BACKGROUND

The present disclosure relates to manipulating a virtual camera dolly in a multi-dimensional space to produce a visual effect.

In today's computing environment, when a user provides a zoom input on a document rendered for display to the user, the current magnification approach as defined by existing systems or technologies, such as Apple Computer's iOS®, magnifies the document until you pass a point where the document is at 100% zoom. Once the document passes 100% magnification, the user sees interpolation artifacts that look like dithering or anti-aliasing. These interpolation artifacts resulting beyond the 100% zoom level sometime cause flickering on a user's screen, a performance lag, and/or other unnatural artifacts that degrade the overall user experience especially when the user is dealing with a 3D document via a web-browser.

### SUMMARY

According to one innovative aspect of the subject matter described in this disclosure, a system includes one or more processors and one or more memories storing instructions that, when executed by the one or more processors, cause the system to, render a set of containers including corresponding contents for display via a viewport in a multi-dimensional space, receive a content movement input, determine a visual effect to apply to the content based on the content movement input and a position of the content relative to a boundary associated with an anchor position in the multi-dimensional space, and manipulate a virtual camera dolly to produce the visual effect, the virtual camera dolly representing a viewing perspective for viewing the content via the viewport in the multi-dimensional space.

In general, another innovative aspect of the subject matter described in this disclosure may be embodied in methods that include rendering, using one or more computing devices, content for display via a viewport displaying a virtual multi-dimensional space; receiving, using the one or more computing devices, a content movement input; determining, using the one or more computing devices, a visual effect to apply to the content based on the content movement input and a position of the content relative to a boundary associated with an anchor position in the multi-dimensional space; and manipulating, using the one or more computing devices, a virtual camera dolly to produce the visual effect, the virtual camera dolly representing a viewing perspective for viewing the content via the viewport in the multi-dimensional space.

Other implementations of one or more of these aspects include corresponding systems, apparatus, and computer programs, configured to perform the actions of the methods, encoded on computer storage devices.

These and other implementations may each optionally include one or more of the following features, such as determining, using the one or more computing devices, one or more input parameters associated with the content movement input; determining, using the one or more computing devices, whether the position of the content reaches to an end of the boundary associated with the anchor position in the multi-dimensional space; that determining the visual effect to apply to the content includes calculating, using the one or more computing devices, a first force to arrest a translation of the virtual camera dolly based on the one or more input parameters and the position of the content being reached to the end of the boundary; that manipulating the virtual camera dolly to produce the visual effect includes applying, using the one or more computing devices, the first force to the virtual camera dolly to arrest the translation of the virtual camera dolly in the multi-dimensional space; that determining the visual effect to apply to the content further includes calculating, using the one or more computing devices, a second force to translate the virtual camera dolly from a first position to a second position based on the one or more input parameters and the position of the content not being reached to the end of the boundary; that manipulating the virtual camera dolly to produce the visual effect further includes applying, using the one or more computing devices, the second force to the virtual camera dolly to translate the virtual camera dolly from the first position to the second position in the multi-dimensional space; that the one or more input parameters include one or more of a velocity with which the content movement input is performed, a direction in which the content movement input is performed, and a magnitude associated with the content movement input; that the content movement input includes a zoom input or a scroll input; that the boundary is determined dynamically relative to the anchor position in the multi-dimensional space; and that the boundary is pre-determined relative to the anchor position in the multi-dimensional space.

These implementations are particularly advantageous in a number of respects. For instance, the technology described herein produces a visual effect, such as a zoom effect, in multi-dimensional 2D, 3D, etc., space. The technology applies the visual effect to a virtual camera dolly to achieve a similar, but improved effect on the object as compared to existing technologies. For instance, the produced effect eliminates or substantially reduces jitter and/or flicker as compared to existing technologies, which results in a smoother and more natural experience for users especially when zooming or panning objects. It should be understood, however, that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

This disclosure is illustrated by way of example, and not by way of limitation in the figures of the accompanying drawings in which like reference numerals are used to refer to similar elements.

FIG. 1 is a block diagram illustrating an example system for manipulating a virtual camera dolly in multi-dimensional space to produce a visual effect.

FIG. 2A is a block diagram illustrating an example client device.

FIG. 2B is a block diagram illustrating an example software application.

FIG. 2C is a block diagram illustrating an example performance framework.

FIG. 2D is a block diagram illustrating various structure, acts, and/or functionality of the example performance framework.

FIG. 3 is a flowchart of an example method for manipulating a virtual camera dolly in multi-dimensional space to produce a visual effect.

FIGS. 4A and 4B are flowcharts of an example method for manipulating a virtual camera dolly in multi-dimensional space to produce a visual effect based on a zoom input.

FIGS. 5A and 5B are flowcharts of an example method for manipulating a virtual camera dolly in multi-dimensional space to produce a visual effect based on a scroll input.

FIGS. 6A and 6B are diagrams illustrating an example spring effect applied to an example virtual camera dolly based on a zoom motion.

FIGS. 7A and 7B are diagrams illustrating an example rubber band effect applied to an example virtual camera dolly based on a scroll motion.

### DETAILED DESCRIPTION

The performance technology described herein can manipulate a virtual camera dolly in multi-dimensional space to produce a visual effect. The visual effect may include, for example, a kinematic effect such as a movement or a translation or may include a spring or rubber band effect to arrest the movement or the translation, although other variations are also possible. An observer/user, which can be a person providing movement inputs using a pointer device, a touch surface, an open-air gesture device, etc., can view and/or interact with a set of surfaces in a rendered context via a viewport. The viewport acts like a window for viewing into a multi-dimensional (e.g., 3D) space where the surfaces are rendered and translated. In some instances, the viewport may be a multi-dimensional viewport capable of displaying the surfaces in 2D or 3D. The viewport may be fixed or may be translated by the performance technology independent of or in conjunction with the surfaces viewable via the viewport. In some implementations, the viewport may correspond to the surface that coincides with either a screen of the device being used (e.g., a smartphone, tablet, television, projector, etc.) or a window or sub-window displayed on such a device.

The surfaces can be rendered and displayed within the viewport. These surfaces can be populated with a variety of contents for display to a user via a web browser. Example contents may include documents or document fragments containing text, graphics, video, audio, etc. As a further example, contents may be or include without limitation, webpages, webpage content, local and or remote files (e.g., portable document format (PDF) documents, spreadsheets, presentations, word processing documents, etc.), electronic books (e-books), digital videos, digital audio files, vector graphic files, social network feeds, syndication feeds, other content feeds, messages (e.g., email, instant messages, etc.), etc. The surfaces may or may not be displayed within the viewport. If a surface is off-screen, it may still exist but not be visible and not require computation to render it. Every surface, including the viewport, can be arbitrarily translated to anywhere else in the multi-dimensional space and every one of these surfaces can have their translation impacted by the calculations produced by the movement inputs.

The performance technology, which may be embodied, at least in part, by the performance framework discussed herein, can manipulate or translate a virtual camera dolly in multi-dimensional space to produce a visual effect via a viewport. The visual effect may include, as discussed elsewhere herein, a movement or translation of surfaces affected by a movement input (e.g., scroll, drag, swipe, zoom, etc.) from one position to another. In some instances, the visual effect may also include an arrestation effect to arrest the movement or translation of affected surfaces beyond a particular anchor position defined in the multi-dimensional space. The anchor position defines a particular boundary in the multi-dimensional space up to which the surfaces may be translated or rendered for display via the viewport. In some implementations, once the edge of the surfaces reaches the anchor position, a spring or rubber band effect may be applied to the virtual camera dolly.

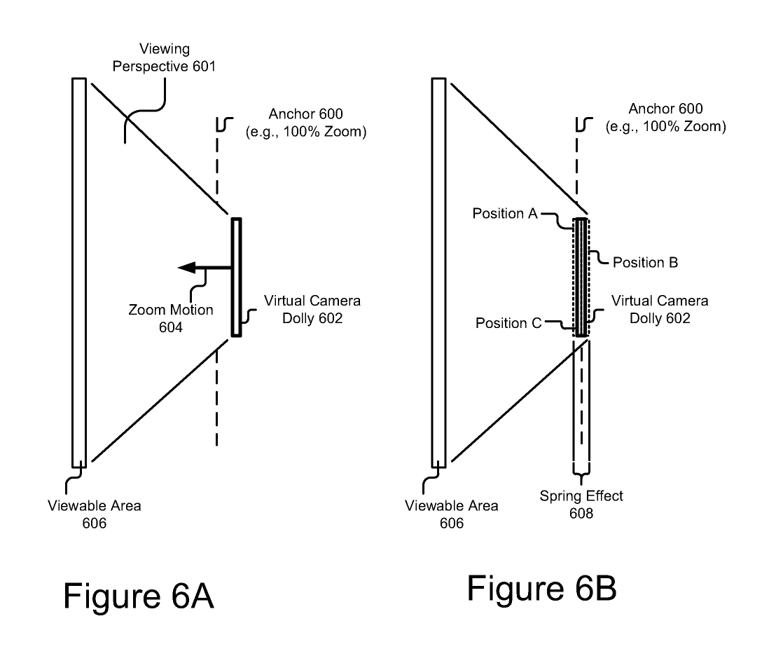

FIGS. 6A and 6B are diagrams illustrating an example spring effect applied to an example virtual camera dolly based on a zoom motion. In particular, FIG. 6A depicts a viewable area 606, which reflects the portion of the total content that is visible to the user. The viewing perspective 601 of the viewable area changes based on the position of the virtual camera dolly 602 relative to the viewable area 606. The virtual camera dolly 602 can move in the backward and forward direction (relative to the viewable area 606). For instance, the position of the virtual camera dolly 602 may change based on a type of zoom (e.g., zoom in, zoom out) and/or an amount of the zoom input by a user via an input device (e.g., a touchscreen displaying the viewable area 606).

By way of non-limiting example, as the virtual camera dolly moves forward toward the viewable area 606, the viewing perspective 601 progressively narrows, thus enlarging the content at the center of the viewable area 606, and the opposite result is achieved as the virtual camera dolly moves backwards away from the viewable area 606. For instance, as depicted in FIG. 6A, the virtual camera dolly 602 can translate in direction of the viewable area 606 to produce a zoom motion 604, thereby zooming in on the contents in the viewable area 606. The anchor 600 in this case specifies a zoom threshold (e.g., a 100% zoom) that the virtual camera dolly 602 can go into before a counter-force (e.g., spring back effect 608) is applied to it as illustrated in FIG. 6B.

FIG. 6B illustrates the spring effect 608 once the virtual camera dolly 602 goes beyond the anchor 600 (e.g., beyond 100% zoom) while translating forward in the direction of the viewable area 606 based on the zoom motion 604. As depicted, the virtual camera dolly 602 while translating reaches a position A, which is beyond maximum certain zoom capacity (e.g., 100%) specified by the anchor 600. Once the virtual camera dolly 602 reaches position A, the spring effect 608 is applied to the virtual camera dolly 602, which applies a dampening force that causes the dolly 602 to reverberate between position A and position B until it settles to a steady state at position C.

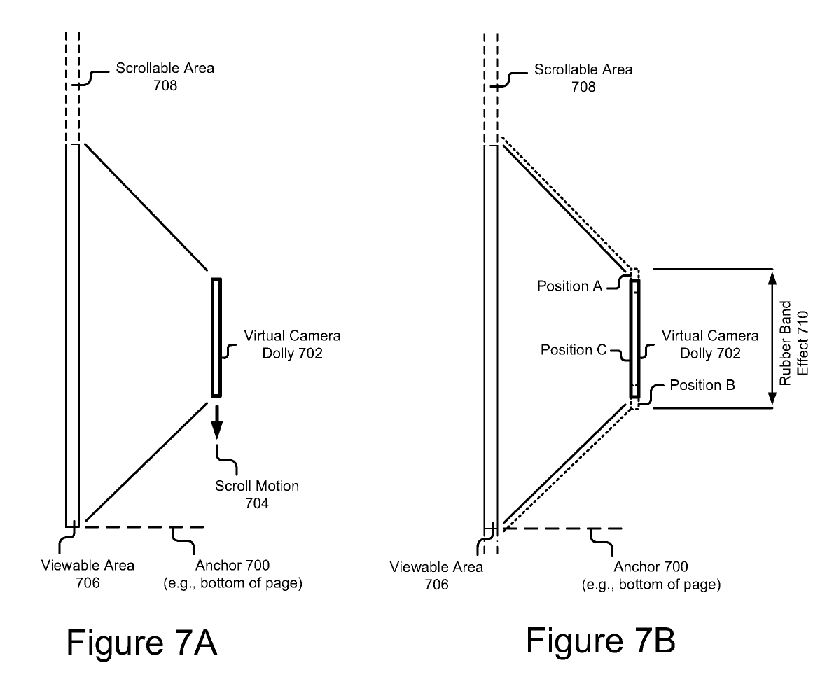

FIGS. 7A and 7B are diagrams illustrating an example rubber band effect applied to an example virtual camera dolly based on a scroll motion. In particular, FIG. 7A depicts a viewable area 706, which reflects the portion of the total content that is visible to the user. A user can view other portions of the content (e.g., upper sections of a page) by scrolling up from the viewable area 706 to the scrollable area 708. The virtual camera dolly 602 moves upward and downward relative to the viewable area based on a scroll input and direction of the scroll provided by a user. For instance, as depicted in FIG. 7A, the virtual camera dolly 602 may translate in the downward direction based on the scroll motion 704, thereby displaying contents via the viewable area 706 to the user. The anchor 700 in this case specifies a terminal threshold of the content that can scrolled by the user.

FIG. 7B illustrates the rubber band effect 710 that can be applied once the virtual camera dolly 702 goes beyond the anchor 700 (e.g., which reflects the bottom of page) while translating in the downward direction based on the scroll motion 704. As the anchor 700 is engaged, a dampening force is applied to the virtual camera dolly 702, which causes the virtual camera dolly 702 to reverberate between position B and position A and eventually come to a steady state at position C.

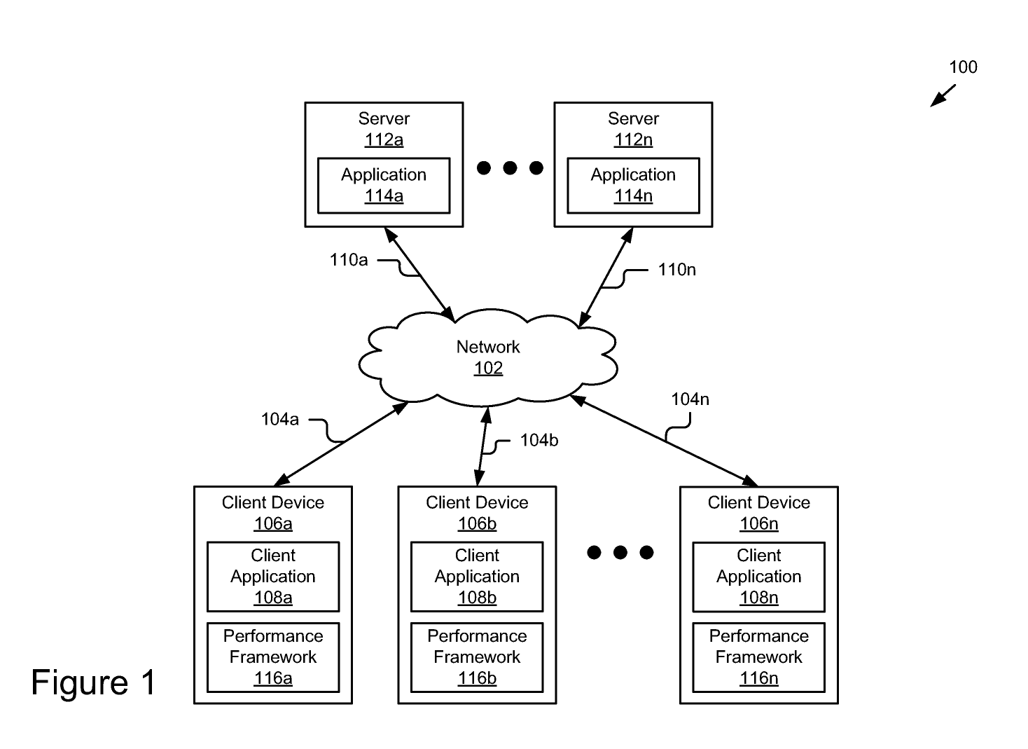

FIG. 1 is a block diagram of an example system 100 for manipulating a virtual camera dolly in multi-dimensional space to produce a visual effect. The illustrated system 100 includes client devices 106a . . . 106n and servers 112a . . . 112n, which are communicatively coupled via a network 102 for interaction with one another. For example, the client devices 106a . . . 106n may be respectively coupled to the network 102 via signal lines 104a . . . 104n, and may respectively include client applications 108a . . . 108n and performance frameworks 116a . . . 116n. The servers 112a . . . 112n may be respectively coupled to the network 102 via signal lines 110a . . . 110n. The use of the nomenclature “a” and “n” in the reference numbers indicates that the system 100 may include any number of those elements having that nomenclature.

The network 102 may include any number of networks. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, peer to peer (P2P) networks, close proximity communication networks (e.g., Bluetooth®, NFC, etc.), various combinations thereof, etc.

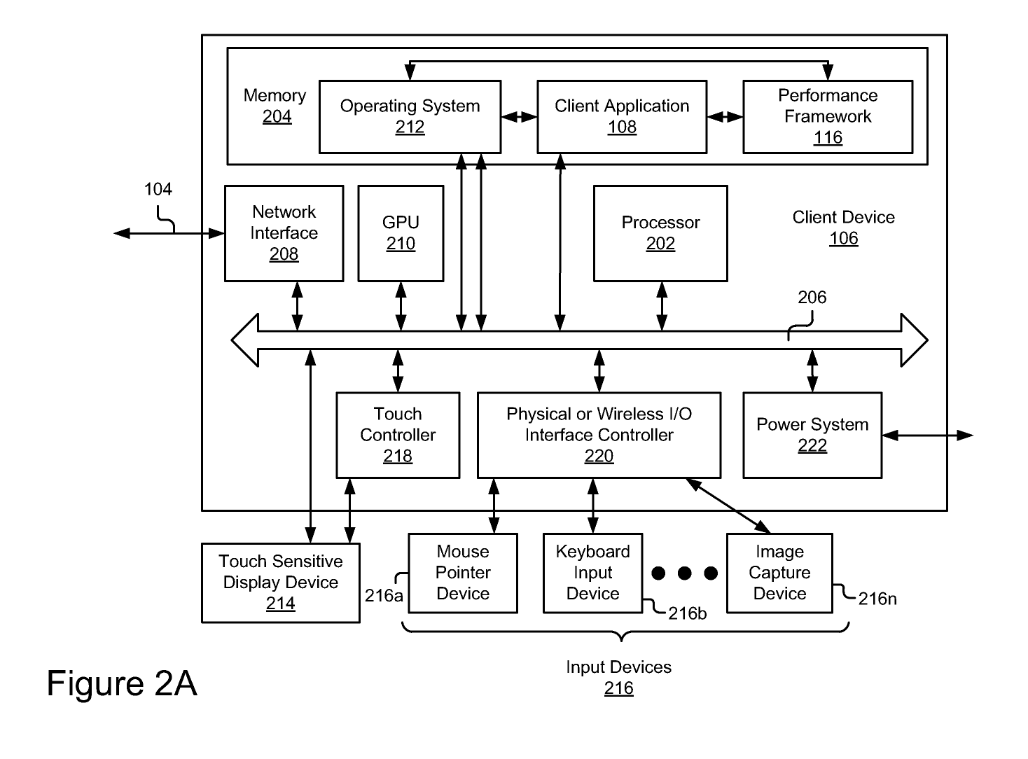

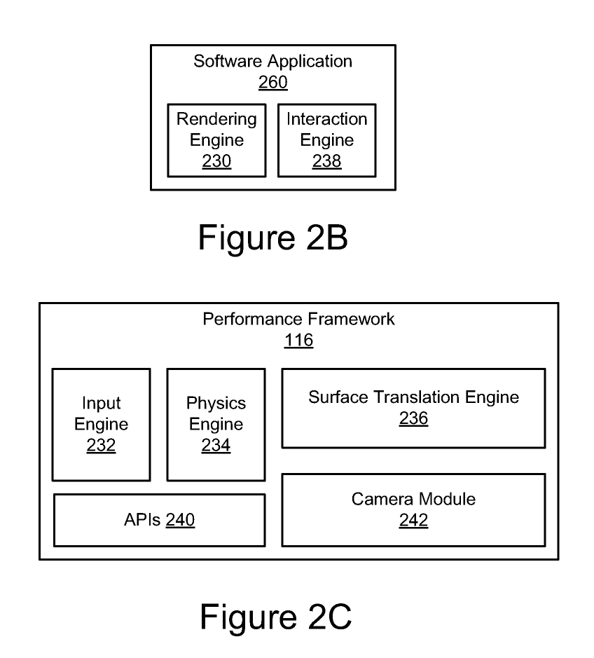

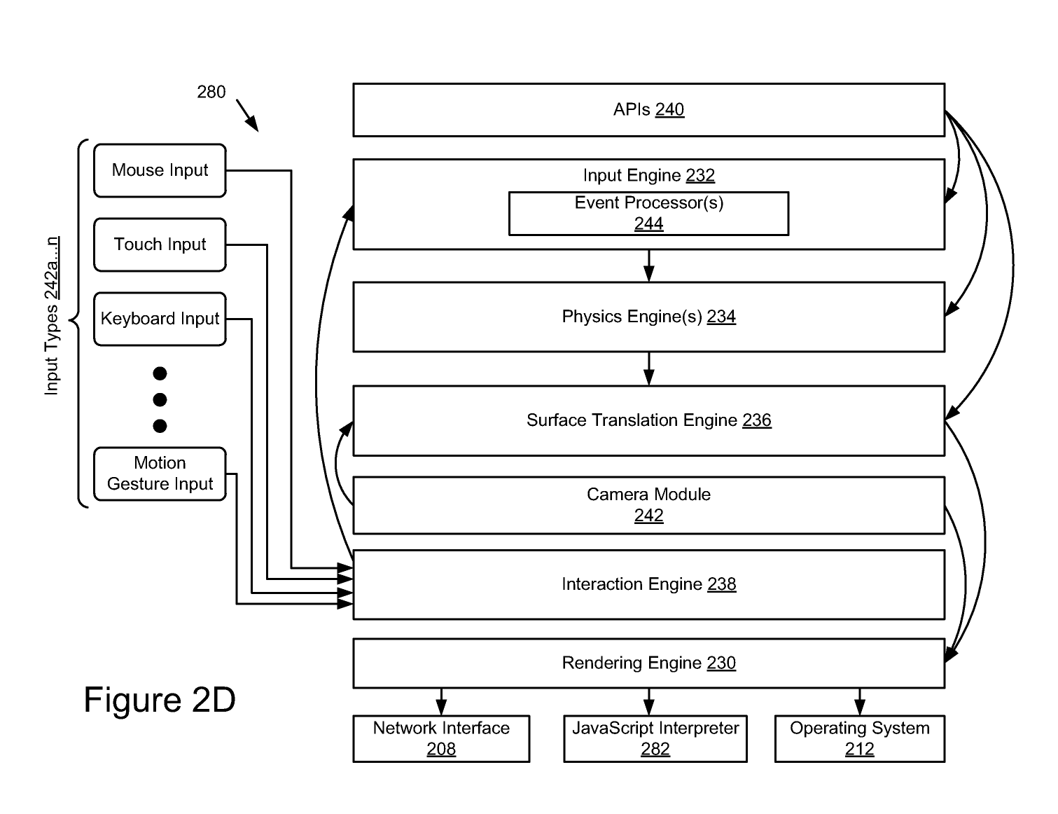

The client devices 106a . . . 106n (also referred to individually and collectively as 106) are computing devices having data processing and communication capabilities. In some implementations, a client device 106 may include a processor (e.g., virtual, physical, etc.), a memory, a power system, a network interface, a GPU, a touch controller, a physical or wireless I/O interface controller, a display device, an input device as shown in FIG. 2A, and/or other software and/or hardware components, including, for example, wireless transceivers, keyboard, camera, sensors, firmware, operating systems, drivers, various physical connection interfaces (e.g., USB, HDMI, etc.). The client devices 106a . . . 106n may couple to and communicate with one another and the other entities of the system 100 via the network 102 using a wireless and/or wired connection.

Examples of client devices 106 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing devices.

In the depicted implementation, the client devices 106a . . . 106n respectively contain instances 108a . . . 108n of a client application (also referred to individually and collectively as 108) and instances of a performance framework 116a . . . 116n (also referred to individually and collectively as 116). The client application 108 and the performance framework 116 may be storable in a memory (e.g., memory 204 as shown in FIG. 2A) and executable by a processor (e.g., processor 202 as shown in FIG. 2A) of a client device 106, implementable using a hardware solution (e.g., ASICs, field programmable gate arrays), a combination of the foregoing, etc.

The client application 108 may include a browser application that can retrieve and/or process information hosted by one or more entities of the system 100 (for example, the servers 112) and can present the information on a display device (e.g., touch sensitive display device 214 as shown in FIG. 2A) on the client device 106.

In an implementation, the performance framework 116 is configured to manipulate a virtual camera dolly to produce visual effects via a viewport in multi-dimensional space in cooperation with the client application 108, an operating system, and/or other components. In some implementations, the performance framework 116 may produce the visual effects by translating the virtual camera dolly from one position to another position or by arresting the translation of the virtual camera dolly as shown for example in FIGS. 6A-6B and 7A-7B, although numerous other applications are possible and contemplated. Additional acts and/or functionality of the client application 108 and the performance framework 116 are discussed in further detail elsewhere herein.

The servers 112a . . . 112n (also referred to individually and collectively as 112) may each include one or more computing devices having data processing, storing, and communication capabilities. For example, a server 112 may include one or more hardware servers, server arrays, storage devices and/or systems, etc. In some implementations, the servers 112a . . . 112n may include one or more virtual servers, which operate in a host server environment and access the physical hardware of the host server including, for example, a processor, memory, storage, network interfaces, etc., via an abstraction layer (e.g., a virtual machine manager).

In the depicted implementation, the servers 112a . . . 112n include applications 114a . . . 114n (also referred to individually and collectively as 114) operable to provide various computing functionalities, services, and/or resources, and to send data to and receive data from the other entities of the network 102, such as the client devices 106. For example, the application 114 may provide functionality for user account management, internet searching; social networking; web-based email; word-processing; banking; finance; blogging; micro-blogging; photo management; video, music and multimedia hosting, distribution, and sharing; business services; news and media distribution; any combination of the foregoing services; etc. It should be understood that the application 114 is not limited to providing the above-noted services and may include other network-accessible services.

The applications 114 may transmit electronic files and/or data embodying the services they provide to the client devices 106 for rendering by the client application 108 operable thereby. In some implementations, the electronic files and/or data streams may be formatted using a markup language(s) (e.g., HTML, XML, etc.), as objects (e.g., JSON), style sheet(s) (e.g., CSS, XSL, etc.), graphic(s) (e.g., PNG, JPG, GIF, etc.), and/or scripts (e.g., JavaScript, ActionScript, etc.), and the client devices 106 may interpret and/or execute the electronic files and/or data streams and render an interactive Web User Interface (WUI) for presentation to users on a display device (e.g., touch sensitive display device 214 as shown in FIG. 2A).

It should be understood that the system 100 illustrated in FIG. 1 is representative of an example system for manipulating a virtual camera dolly in multi-dimensional space to produce a visual effect, and that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the system may be integrated into to a single computing device or system or additional computing devices or systems, etc.

FIG. 2A is a block diagram of an example client device 106, which includes various hardware and/or software components. As depicted, the client device 106 may include a processor 202, a memory 204, a network interface 208, a GPU (graphical processing unit) 210, a touch controller 218, a physical or wireless I/O interface controller 220, a power system 222, a touch sensitive display device 214, and one or more input devices 216a . . . 216n (also referred to individually and collectively as 216), which may be communicatively coupled by a communication bus 206. The client device 106 depicted in FIG. 2A is provided by way of example and it should be understood that it may take other forms and include additional or fewer components without departing from the scope of the present disclosure.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single core or plurality of processing units and/or cores. In some implementations, the processor 202 may be capable of generating and providing electronic display signals to a display device (e.g., the touch sensitive display device 214), supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the client device 106 including, for example, the memory 204, the network interface 208, the GPU 210, the touch controller 218, the physical or wireless I/O interface controller 220, the power system 222, the touch sensitive display device 214, and the input devices 216.

The memory 204 may store and provide access to data to the other components of the client device 106. In some implementations, the memory 204 may store instructions and/or data that may be executed by the processor 202. For example, as depicted, the memory 204 may store an operating system 212, the client application 108, and the performance framework 116. The memory 204 is also capable of storing other instructions and data, including, for example, hardware drivers, other software applications, databases, etc. The memory 204 may be coupled to the bus 206 for communication with the processor 202 and the other components of the client device 106.

The memory 204 includes a non-transitory computer-usable (e.g., readable, writeable, etc.) medium, which can be any tangible apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blu-Ray™ etc.). It should be understood that the memory 204 may be a single device or may include multiple types of devices and configurations.

The bus 206 can include a communication bus for transferring data between components of a computing device or between computing devices, a network bus system including the network 102 or portions thereof, a processor mesh, a combination thereof, etc. In some implementations, the memory 204, the network interface 208, the GPU 210, the touch controller 218, the physical or wireless I/O interface controller 220, the power system 222, the touch sensitive display device 214, and/or the input devices 216 operating on the client device 106 may cooperate and communicate via a software communication mechanism implemented in association with the bus 206. The software communication mechanism can include and/or facilitate, for example, secure and/or unsecure inter-process communication, local function or procedure calls, remote procedure calls, an object broker, direct socket communication among software modules, UDP broadcasts and receipts, HTTP connections, etc.

The network interface 208 may include one or more interface devices for wired and wireless connectivity with the network 102 and the other entities and/or components of the system 100 including, for example, the servers 112, etc. For instance, the network interface 208 may include, but is not limited to, CAT-type interfaces; wireless transceivers for sending and receiving signals using Wi-Fi™; Bluetooth®, cellular communications, etc.; USB interfaces; various combinations thereof; etc. The network interface 208 may be coupled to the network 102 via the signal line 104 and may be coupled to the other components of the client device 106 via the bus 206. In some implementations, the network interface 208 can link the processor 202 to the network 102, which may in turn be coupled to other processing systems. The network interface 208 can provide other connections to the network 102 and to other entities of the system 100 using various standard communication protocols, including, for example, those discussed elsewhere herein.

The graphical processing unit (GPU) 210 may render one or more images for display by performing various input/output, logical, and/or mathematical operations. The GPU 210 may have various computing architectures to process data signals including, for example, a parallel processing architecture, a complex instruction set computer (CISC) architecture, a reduced instruction set computer (RISC) architecture, and/or an architecture implementing a combination of instruction sets. The GPU 210 may be physical and/or virtual, and may include a single core or plurality of processing units and/or cores. In some implementations, the GPU 210 may be capable of generating and providing electronic display signals to the touch sensitive display device 214, supporting the display of images, capturing and transmitting images, performing complex tasks including various types of feature extraction and sampling, etc. In some implementations, the GPU 210 may be coupled to the memory 204 via the bus 206 to access data and instructions therefrom and store data therein. In some implementations, the GPU 210 may perform its acts and/or functionalities as described herein in cooperation with the processor 202 and/or one or more components of the client device 106. For instance, the bus 206 may couple the GPU 210 to the processor 202 and other components of the client device 106 including, for example, the memory 204, the network interface 208, the touch controller 218, the physical or wireless I/O interface controller 220, the power system 222, the touch sensitive display device 214, and/or the input devices 216. In some implementations, the GPU 210 may be integrated with the processor 202.

The touch sensitive display device 214 is a touch-screen display (e.g., OLED, AMOLED, etc.) capable of receiving input from one or more fingers of a user. For example, the touch sensitive display device 214 may be a capacitive touch-screen display capable of detecting and interpreting multiple points of contact with the display surface. The touch sensitive display device 214 may be managed by a touch controller 218, which relays and/or passes the inputs/signals received on the display device 214 to one or more components of the client device 106 including, for example, the GPU 210, the processor 202, the memory 204, the network interface 208, etc., via the bus 206. The touch sensitive display device 214 may include one or more transparent touch sensitive layers that are integrated with the touch sensitive display device 214 and capable of sensing input/gestures from the one or more fingers of a user. While a touch sensitive display is described, it should be understood that a conventional display device (e.g., LCD, projector, TV, etc.) is also applicable and may be used.

The input devices 216a . . . 216n (also individually and collectively referred to as 216) may include motion-detecting input devices, pointer devices, keyboards, audio input devices, other touch-based input device, etc. For example, the input devices 216 may include a touch-screen, microphone, a front facing camera, a rear-facing camera, and/or motion sensors, etc. In particular, as depicted in the figure, the input devices 216 may include a pointer device 216a (e.g., a mouse, trackpad, etc.), a keyboard input device 216b, an image capture device 216n, etc. The input devices 216 may be managed by a physical or wireless I/O interface controller 220, which relays and/or passes the inputs/signals received from users via the input devices 216 to one or more components of the client device 106 including, for example, the touch controller 218, the touch sensitive display device 214, the GPU 210, the processor 202, the memory 204, the network interface 208, etc., via the bus 206.

The input devices 216a . . . 216n and/or the touch sensitive display device 214 may be configured to receive a variety of control inputs (e.g., gestures) from users. Non-limiting examples of the inputs may include a single touch gesture (e.g., swipe, tap, flick, stroke, scroll, etc.), a multiple touch gesture (e.g., zoom, grab, etc.), a mouse click, a keyboard stroke, a voice gesture (e.g., speech to text, voice command, etc.), a motion gesture (e.g., hand signal, body signal, eye movement, etc.), a thought gesture (e.g., various signals from brain electrodes), etc.

The power system 222 includes a power source and/or components for supplying electrical power to the components of the client device 106. As depicted, the power system 222 may be coupled to the bus 206 to provide power to the hardware components coupled thereto. In some implementations, the power system 222 may include one or more of a regulated power supply (e.g., AC power supply), a transformer (AC/DC converter), one or more energy storage devices (e.g., a rechargeable battery), wiring, etc.

FIG. 2B is a block diagram of an example software application 260. In some implementations, the software application 260 represents the client application 108 and/or the operating system 212, although the software application 260 may also represent other types of software like native applications. As depicted, the software application 260 may include a rendering engine 230 and an interaction engine 238.

The rendering engine 230 may include software and/or logic for processing content and formatting information for display. The rendering engine 230 can coordinate visual effects to be applied to a renderable context with the movement inputs provided by a user for the context so the experience is responsive and satisfying to the user. A renderable context can include one or more objects that are capable of interacting with one another and that could affect another's behavior within the context.

In some implementations, the rendering engine 230 may define an anchor position in multi-dimensional space. The anchor position may define a specific position in the multi-dimensional space up to which contents may be positioned for display in a viewport (e.g., see anchors 600 and 700 as shown in FIGS. 6A-6B and 7A-7B). In some instances, a boundary may be associated with the anchor position. The anchor position and, thus the boundary, may be pre-determined or dynamically determined relative to an aspect of the rendered context or viewport (e.g., a boundary of or position in the viewport). In some instances, the boundary may coincide with or be located at the anchor position (e.g., a boundary=the anchor position). In other instances, the boundary may be situated a pre-determined distance away from the anchor position. Other variations are also possible and contemplated.

In some instances, the boundary associated with the anchor position may be used by one or more components of the performance framework 116 to determine what visual effects need to be produced on a rendered context upon receiving a user input. In some instances, this determination may be based on a current position of content in the rendered context relative to the boundary. For example, if the performance framework 116 receives a scroll input and the current position of the content being scrolled has not reached the boundary associated with the anchor position, then the performance framework 116 may produce a visual effect to translate from the current position in the rendered context to another position based on the scroll. In another example, if the performance framework 116 receives a scroll input and the current position of the content has already reached the boundary associated with the anchor position, then the performance framework 116 may produce a visual effect to arrest the translation based on the scroll (such as a rubber band effect shown in FIG. 7B).

In some instances, the rendering engine 230 may generate a rendering from scene data, which can be displayed on a display device, such as the touch sensitive display device 214. For example, the rendering engine 230 may receive a scene graph from the surface translation engine 236 (e.g., see FIG. 2C), in which necessary matrices transformations have already been calculated. In some instances, geometric, modeling, camera, and/or other transforms may already be performed by the surface translation engine 236 based on information received from the physics engine 234 and/or the input engine 232 (e.g., see FIG. 2C). This can reduce or eliminate the amount of matrix multiplication (e.g., translation, scaling, rotation, projection, etc.) that needs to be performed by the rendering engine 230, thus substantially improving the overall performance (e.g., speed and visual quality) of the software application 260.

In some instances, the rendering engine 230 renders content based on a viewing perspective of a virtual camera dolly generated by the camera module 242. For example, the virtual camera dolly may represent the viewing perspective from which content and visual effects are perceived in the viewport. The rendering engine 230 may base its renderings on the viewing perspective so contents are displayed to user using that viewing perspective on a display device, such as the touch sensitive display device 214. By way of another example, the virtual camera dolly 602 generated by the camera module 242 may have a viewing perspective 601 as shown in and discussed further herein with respect to FIG. 6A. The rendering engine 230 may coordinate with the camera module 242 to render content using the viewing perspective 601. In some instances, the surface translation engine 236 may generate a scene graph based on the viewing perspective provided by the camera module 242 and the rendering engine 230 may then render the scene graph as discussed above.

The rendering engine 230 can utilize APIs that provide direct access to GPU hardware acceleration and primitives for efficient translation of objects (e.g., containers, documents, document fragments, etc.) in multiple dimensions (e.g., 2D, 3D, etc.). For example, the rendering engine 230 may utilize a graphics stack to efficiently rasterize vector graphics into raster images (e.g. pixels) for display via a screen. Using the scene graphs generated and provided to the rendering engine 230 by the surface translation engine 236 (e.g., see FIG. 2C), the rendering engine 230 can render the content sufficiently fast (e.g., @60 fps) so that the animations being applied to viewable containers are smooth and seamless to the viewer, and undesirable artifacts (e.g., jitter) are eliminated.

In some implementations, the rendering engine 230 may process markup content like HTML, XML, JSON, etc., apply presentational instructions encoded in CSS, XSLT, etc. to the markup content, interact with a JavaScript Interpreter to execute various objects, methods, etc., that may manipulate the content, and then provide the formatted content for display to a user on the display device 214.

As shown in FIG. 2D, the rendering engine 230 may be coupled to the network interface 208 to send and receive data (e.g., via the network 102). The rendering engine 230 may be coupled to the JavaScript Interpreter 282 to interpret JavaScript objects configured to handle and process events, perform physics-related calculations, generate scene graphs, control various aspects of the software application 260, communicate with other entities (e.g., asynchronously), manipulate the content being process for display (e.g., DOM elements, etc.), etc. The rendering engine 230 may be coupled to the operating system 212 to store and access files via a file system, access one or more databases, utilize various APIs, etc., receive instructions, etc.

The interaction engine 238 may include software and/or logic for receiving and interpreting user input from the input devices 216. The interaction engine 238 may be coupled to receive movement inputs from touch controller 218 that are input by users via the touch sensitive display device 214 and/or the input devices 216. In some implementations, the touch controller 218 may determine and provide positional information associated with each point of contact with the touch sensitive display device 214 to the interaction engine 238. The interaction engine 238 may interpret the inputs and/or provide data describing the inputs to the input engine 232.

FIG. 2C is a block diagram of an example performance framework 116, which includes an input engine 232, a physics engine 234, a surface translation engine 236, APIs 240, and a camera module 242. FIG. 2D is a block diagram illustrating various structure, acts, and/or functionality of the example performance framework 116. The input engine 232, the physics engine 234, the surface translation engine 236, the APIs 240, and/or the camera module 242 may be communicatively coupled by the bus 206 and/or the processor 202 to one another and/or the other components 204, 208, 210, 214, 216, 218, 220, and/or 222 of the client device 106. In some implementations, one or more of the input engine 232, the physics engine 234, the surface translation engine 236, the APIs 240, and/or the camera module 242 are sets of instructions executable by the processor 202 to provide their functionality. In other implementations, one or more of the input engine 232, the physics engine 234, the surface translation engine 236, the APIs 240, and/or the camera module 242 are stored in the memory 204 of the client device 106 and are accessible and executable by the processor 202 to provide their functionality. In any of the foregoing implementations, the input engine 232, the physics engine 234, the surface translation engine 236, the APIs 240, and/or the camera module 242 may be adapted for cooperation and communication with the processor 202 and other components of the client device 106.

The input engine 232 includes software and/or logic for receiving and processing inputs provided by a user interacting with a rendered context. As described elsewhere herein, a renderable context can include one or more objects that are capable of interacting with one another and that could affect another's behavior within the context. The renderable context and/or objects are also interchangeably referred to herein in some cases as surfaces. In some implementations, a rendered context may be a viewport (e.g., a window, a frame, an HTML container element, etc.) and may include elements within it, such as scroll views, containers, images, media objects, etc. The elements may be visible or non-visible to a viewer. In a 3D virtual space, a rendered context may be a heads-up display that is presented to a user on top of another context that is 3D interactive working space. Each rendered context may be associated with one or more instances of a physics engine 234, as discussed in further detail elsewhere herein.

The inputs received and processed by the input engine 232 may correspond to various input types provided by a user using one or more input devices 216, as described elsewhere herein. For instance, the inputs types may include, for example, mouse inputs, touch inputs, keyboard inputs, motion (e.g., open-air) gesture inputs, etc. In a further example, the inputs may be touch or motion-based inputs respectively captured by the touch sensitive display device 214 and the image capture device 216n. As a further example, the representative inputs may include, but are not limited to, a tap, scroll, swipe, pinch, zoom, rotation, hand motion, body motion, etc. The interaction engine 238 may capture the inputs and send them to the input engine 232 for processing. In some instances, a surface rendered for display may be notified of an event by the interaction engine 238, and may pipe the event to the input engine 232 for processing.

How various events are handled for a given context, and whether or not the events affect the context, may be defined in association with the context. For example, an interface designer may predetermine the effects certain user gestures will have on the rendered context and the elements it includes, and can add corresponding event emitters (e.g., using JavaScript) to the context that trigger processing of associated events by the input engine 232 when such events are detected relative to the context.

In some implementations, events can be abstracted as streams and based off of a software object configured to handle the events, such as an event emitter (e.g., a node.js EventEmitter). In some implementations, to handle a particular event, a context, its objects, etc., may implement an emit method, which may be called by the event emitter to provide notification that an event has occurred. The event emitter may implement a pipe method, which adds a given target to a list of one or more targets to which an event will be piped to, and may implement an unpipe method to remove the target from the list. An event handler library may also be used in conjunction with event emitters to process the events. The event emitter may emit an event, and the event data for that event may be dispatched to a handler, for instance, by calling an on(eventName, handler) function with a corresponding argument. For example, the emit( ) method may be used to emit an event, and the on( ) function may attach a handler to an event (which can be dispatched on emit). The pipe( )method may designate downstream event handler to emit events to. An event handler may be designated to be used for input and output. In some cases, if both the functions (e.g., input and output) are desired, then two separate event handlers may be required and used. An unbind(eventName, handler) method may be called to step dispatching events to the handler that was added using the on method. Events may originate from various event sources including events from the viewport, events from the performance framework 116, and events from the containers (e.g., DOM elements representing the containers). Remote events may also be received by a local instance of the performance framework 116 from one or more remote instances of the performance framework 116, allowing for a multi-screen implementation.

In some instances, the interaction engine 238 of a web browser, operating system, or other application may capture an event with respect to one or more contexts, which may trigger the event listener defined in association with the context(s), and the event may be piped to the input engine 232, where it is processed and then output to one or more instances of the physics engine 234 that correspond to the context(s).

As a further example, an input received from the interaction engine 238 may, in some cases, be received as an HTML event and may be tied to one or more containers. The HTML event may include positional information associated with the user input and information about what target surface(s) are affected. As an example, a given containers in an HTML document rendered for display, and user inputs received corresponding with that container may be captured upon input by the interaction engine 238 and piped to the input engine 232 for processing.

The input engine 232 can consider the input history to determine how to process the current input. In some implementations, the input engine 232 may interpret and integrate a current input (e.g., low-level event) with a set of previous inputs reflecting higher level event (e.g., a rotate gesture, zoom gesture, a combination of the foregoing, etc.) based on the properties of the low-level event. For instance, the input engine 232 may determine whether the input event is a new touch or a continuation of a series of previous touches. This determination can be based on the connection between the properties of the previous input(s) received and the current input being processed, including movement (target container, difference in position between inputs, continuity between inputs, time elapsed between inputs, etc.). As a further example, for a series of raw inputs that collectively describe a finger swipe across a touchscreen, the input engine 232 can identify the series of raw inputs as forming the swipe. In this example, the event state for the first input in the series may be determined as new, and the event states for the subsequent inputs in the series may be determined as continuous with the first input.

As depicted in FIG. 2D, the input engine 232 may include one or more event processors 244 capable of processing the input events received from the interaction engine 238. In some implementations, the input engine 232 may include various sets of one or more event processors 244 that are each capable of processing different types of events. Representative event processors may include, but are not limited to gesture processors like a pinch processor for processing pinch-to-zoom gestures, a touch processor for processing touch and tap gestures, a touch sync for synchronizing events received from multiple sources, a swipe processor for processing swipe gestures, a hand motion gesture processor for processing one or more hand motions, etc.

In some implementations, an event processor 244 may process an event/input to determine one or more parameters associated with the event. For example, the one or more parameters associated with the event may include a force with which the event was detected on a rendered context, a velocity associated with that event, a position where the event was detected, a direction in which the event was intended to be performed by a user, number of points of contact associated with that event including a single point contact (tap, swipe, drag, flick, etc.), a multi-point contact (zoom in, zoom out, two finger tap, rotate, three-finger swipe, etc.), etc.

The processed events including the parameters associated with these events can be output by the input engine 232 to one or more of the physics engine instances 234 for processing and can then be rendered for display via corresponding rendered context(s). In particular, the input engine 232 can determine the position, velocity, direction, time stamp, event-type, etc., for a given input/event and provide it to a corresponding instance of the physics engine 234. This can be done in (e.g., near) real-time so the physics engine 234 can model the changes to the surface(s) associated with the input, as discussed in further detail below. The input engine 232 may be coupled to one or more instances of the physics engine 234 to provide the event-related information, and may be coupled to the memory 204 to store and/or retrieve event-related information.

The physics engine 234 includes software and/or logic for computing visual effects (e.g., kinematic effects such as movements, translations, etc. and arrestation effects such as spring effects, rubber band effects, etc.) for a rendered context(s) and/or one or more of the objects associated with that context based on event information received from the input engine 232. The event information may include, for example, one or more event parameters such as velocity, position, direction, time stamp, type of event, and other related parameters as described above with respect to the input engine 232. In some implementations, the physics engine 234 may process the event information associated with one or more rendered contexts (e.g., surfaces) to compute forces and/or translations to be applied to these contexts in order to bring the one or more contexts in movement and/or stoppage. In some implementations, the physics engine 234 may send the forces and/or translations computed by it to the surface translation engine 236 and/or the camera module 242 for applying these forces and/or translations to the one or more rendered contexts thereon.

In some implementations, the physics engine 234 for the purpose of computing a visual effect for a rendered context may signal the rendering engine 230 to notify it of the one or more surfaces that are affected by a user input and a current position of these surfaces relative to the boundary associated with the anchor position as discussed above with respect to the rendering engine 230. The physics engine 234 may then use the current position of the affected surfaces in the context and the event-related information received from the input engine 232 to compute a visual effect for the context. For instance, the physics engine 234 may use the current position relative to the boundary to determine whether the visual effect should be a kinematic effect such as translation or an arrestation effect such as spring or rubber band effect.

If the physics engine 234 determines that the current position of the affected surfaces in the context is not at the boundary, then the physics engine 234 may use the event-related information (e.g., one or more event parameters associated with the event/user input) to determine a trajectory associated with the event. For instance, an event may be a scroll input by a user and the physics engine 234 may use one or more parameters associated with the scroll input (as determined by the input engine 232) to determine a trajectory (e.g., path, direction) and a position in the context where the affected surfaces should translate in multi-dimensional space.

If on the other hand, the physics engine 234 determines that the current position of affected surfaces in the context is at the boundary, then the physics engine 234 may compute a spring effect or a rubber band effect to arrest the translation of the affected surfaces beyond the boundary as shown, for example, in FIGS. 6B and 7B. By way of example, if a user provides a scroll input on a surface in the direction of the boundary and the current position of the surface has already reached the boundary, then the physics engine 234 may compute an opposite force to arrest the translation of the surface beyond the boundary as depicted in FIG. 7B.

In some implementations, the physics engine 234 may compute and add one or more energy agents to one or more rendered contexts. The one or more energy agents may act on the one or more contexts based on triggering criteria (e.g., events, random or systematic timers, predetermined criterion, etc.). For instance, a given energy agent may represent the act to be performed when a certain gesture input by a user is received, and or may vary based on the attributes (e.g., velocity, position, etc.) of the input. Example energy agents may include a velocity energy agent that applies movement to a container or set of containers when scrolled or panned, tracking energy agent that applies a tracking movement to a container or set of containers when the user moves the controlling input (e.g., finger, hand, etc.) around the control region (e.g., touch sensitive surface), etc.

As a further example, the physics engine 234 may receive the velocity and position associated with an event that corresponds to a given surface/rendered context. From the container, the physics engine 234 can compute the effect of the event on the container relative to the other energy agent constraints that are associated with that surface. For instance, each time a finger presses and holds down on a surface displayed via the touch sensitive display device 214, and the surface has a tracking energy agent that says the surface should track the movement of the finger, the physics engine 234 computes the tracking effect the tracking energy agent has on the surface relative to any other constraints that may also govern the surface, such as boundary limitations, friction, drag, bounce back, etc. As the finger moves around the screen, the physics engine 234 is informed of the velocity and position of the finger and updates the surface with this movement based on the vector(s) associated with the tracking energy agent and relative to the other forces that are applicable to the container. When the finger is removed from the screen, the input engine 232 ceases to provide events (e.g., touch vectors) to the physics engine 234 for that surface, and the physics engine 234 is thus informed that the surface is no longer being controlled by the input. At this point, the physics engine 234 allows the other energy agents associated with the surface to transition in and bring the surface to a steady state (which could be a static or dynamic state).

It should be understood that energy agents can, in some cases, act independently of input events. Stated differently, an agent might or might not respond to an input, but has an output, which can affect the state of an object. For instance, there can be certain energy agents added to a rendered context that define the environment of the context. As an example, a rotational energy agent may be added to a viewport to slowly rotate the objects (e.g., DOM elements) of the viewport about a center point at a predetermined rate, and after items are spun using a swipe by the user, the spinning motion may eventually returns back to that base rotational state and rate. In another example, a scroll view may include several scrollable elements. The scroll view may have two agents associated with it—a velocity agent and a drag agent. The velocity agent allows the elements to be scrolled quickly based on repeated, rapid user inputs, and the drag agent slows down the scrolling to give it a slowing effect between inputs. As a further example, suppose a user would like to move a few objects (e.g., DOM elements) in a viewport together and basically uses a grab gesture to tosses them into a pile in the viewport. The objects may have a sticky energy agent that adheres the objects together in the pile, and may have a gravity energy agent that opposes the sticky energy agent, causing some of the objects to unstick and fall. Additionally or alternatively, the viewport may have a vortex energy agent that causes all objects (e.g., DOM elements) to rotate around a center point when at steady state.

The physics engine 234 is capable of computing the dynamic state of a context over time. The physics engine 234 can determine how an object (e.g., a surface, a container, etc.) of a context will be affected by events, energy agents, and transitions associated with that context, and can output data describing these effects to the surface translation engine 236 and/or the camera module 242. In some implementations, the data output by the physics engine 234 can include instructions describing visual effect(s) (e.g., translations, movements, spring effect, rubber band effect, etc.) that needs to be applied to surface(s) affected by an input/event in multi-dimensional space. In some other implementations, the data output by the physics engine 234 can further include the energy agents at least in terms of transformation matrices describing how the corresponding object(s) are to be visually affected (e.g., transformed).

The surface translation engine 236 includes software and/or logic for applying translations and/or other visual effects to rendered contexts present in a viewport based on inputs, events, transitions, and/or viewing perspectives. The surface translation engine 236 may be coupled to the physics engine 234 and/or camera module 242 of the performance framework 116 to receive surface-related information, such as corresponding input events, energy agent-related/transformation information, transitions, and/or viewing perspectives.

The surface translation engine 236 may translate rendered contexts based on translation (e.g., trajectory) computed by the physics engine 234 or a viewing perspective computed by the camera module 242 as discussed later below. In some implementations, the physics engine 234 may output position and velocity information associated with an object, which the surface translation engine 236 may then use to apply the corresponding translation. In some implementations, the camera module 242 may provide a viewing perspective to the surface translation engine 236, which the surface translation engine 236 may then use apply the corresponding translation.

In some implementations, the surface translation engine 236 may signal the rendering engine 230 to render one or more contexts for display based on translations applied to these contexts. In some instances, the surface translation engine 236 may apply the translations, other visual effects (e.g., spring or rubber band effects), and/or viewing perspectives in a scene graph and send the scene graph to the rendering engine 230. The rendering engine 230 can use GPU accelerated rendering to process the scene graph and produce the surface translations and/or other effects in the viewport (e.g., browser window). This can yield significant performance improvements and eliminate unwanted visual artifacts when rendering objects, for example, in a web browser context.

A scene graph includes a data structure including nodes that describe renderable content in the form of a tree structure, in which a parent node contains one or more children nodes, and the children nodes may further constitute parent nodes relative to the children nodes they contain, and so one and so forth. Each node of the scene graph may include positional, rotational, scaling, and/or geometrical information, etc., associated with that node, and may include such information in multiple dimensions (e.g., 2D, 3D, etc.), although it should be understood that any other attributes may also be included, such as opacity. In some web browser-based implementations, the surface translation engine 236 may generate the scene graph by progressively applying the transforms beginning with the leaves and ending with the roots, and the rendering engine 230 may apply the scene graph to the DOM in reverse order.

When generating the scene graph, the surface translation engine 236 can format the data received from the physics engine 234 and/or the camera module 242, such as data describing applicable events, viewing perspectives, energy agent effects, and/or transitions, into a scene-graph compatible format and incorporate it. For instance, a change in position, rotation, scale, and/or geometry, etc., due to one or more energy agents may be calculated (e.g., as vectors) by the physics engine 234 and provided to the surface translation engine 236, which may reflect these changes in the node. The surface translation engine 236 may receive information about the rendered context and the one or more objects included therein, such as current position, rotation, scale, geometry, etc., from the rendering engine 230 (e.g., a DOM) and incorporate it into the scene graph. In some implementations, a location matrix can be computed based on scene graph data. The physics engine 326 may be used as a source to compute the location matrix, and the surface translation engine 236 may then apply this location matrix to one or more elements of a rendered context for translation.

The surface translation engine 236 may generate its own distinct scene graph, which it can then provide to the rendering engine 230. The rendering engine 230 can use GPU accelerated rendering to process the scene graph and produce the surface translations and/or other effects in the viewport (e.g., browser window) without having to substantially reprocess the scene graph. In some cases, the nodes of the scene graph are not directly associated with the items being visually displayed, but are rather representations of those items and can be independently transformed by the surface translation engine 236. This can allow the performance framework 116 to be over a magnitude more efficient than when the elements are directly associated with the items being visually displayed and the transformations are processed by the rendering engine 230 itself.

In some implementations, the rendering engine 230 may signal the surface translation engine 236 to output a scene graph (e.g., based on the occurrence of one or more events) for a given renderable context. In some implementations, the surface translation engine 236 may provide the scene graph to the rendering engine 230 responsive to receiving data and/or instructions from the physics engine 234 and/or the camera module 242. Other variations are also contemplated.

The APIs 240 include software and/or logic for interfacing with and providing the functionality of the performance framework 116, and/or its constituent components to another software applications, such as the software application 260, the applications 114a . . . 114n, etc. In some implementations, the APIs 240 relays requests and responses from the other software application to the appropriate components of the performance framework 116 for processing. For example, in an implementation where the application 114 and the performance framework 116 (or portions thereof) reside on distinct computing devices coupled via the network 102, the application 114 may interface with the performance framework 116 via the APIs 240. The APIs 240 may be electronically communicatively coupled to the other components of the performance framework 116 to relay information. For example, in a multi-view implementation where the same physics context is shared via two or more rendered contexts on disparate computing devices, the APIs 240 can receive inputs via the network 102 and the network interface 208, from a remote instance of the performance framework 116, and provide the inputs to a local instance of the input engine 232 for processing and synchronization. The APIs 240 may also provide access to data stored on the computing device. In some implementations, the APIs 240 may require an interfacing software application to authenticate using a standard authentication protocol to utilize its functionality.

The camera module 242 includes software and/or logic for generating a viewing perspective from which contents of a rendered context are perceived via a viewport in multi-dimensional space. In some instances, the cameral module 242 may generate a viewing perspective using a virtual camera. The viewing perspective generated using the virtual camera may simply represent how one or more objects of the rendered context may be perceived on the viewport based on position and angle of the virtual camera relative to the viewport in the multi-dimensional space. For instance, objects on the viewport may be perceived based on how far and in which direction the virtual camera is located from the viewport. In some instances, the virtual camera may work and behave in the same way as a regular digital camera. For example, just like a regular camera, the virtual camera may produce a zoom-in view of a target subject as it is translated closer to the subject and may produce a zoom-out view as it is translated away from the target subject. Non-limiting examples of different viewing perspectives generated by the camera module 242 may include a zoomed view (e.g., 50%, 60%, 100%, 120%, etc.), a pan view, a scroll view, an inverted view, a rotated view, etc.

In some implementations, the virtual camera may be mounted on a camera dolly that moves or rides in various directions (e.g., up, down, left, right, upper left, upper right, lower left, lower right, cardinal directions (e.g., north, south, east, west, etc.) etc.) in order to form a desired viewing perspective of contents on the viewport. For example, as depicted in FIG. 6A, the virtual camera dolly includes the virtual camera and translates towards the viewable area 606 in order to zoom-in the content displayed in the viewable area 606 based on a zoom-in input provided by user. Continuing the same example, the virtual camera dolly 602 can move in the opposite direction of the viewport to zoom-out the content displayed in the viewable area 606 based on zoom-out input provided by the user.

In some implementations, movement of the virtual camera dolly may be based on data and/or instructions received from the physics engine 234. For instance, the camera module 242 may receive visual effects (such as movements, translations, arrestations, forces, etc.) from the physics engine 234 and may then use the effects to move the virtual camera dolly accordingly. By way of example, the physics engine 234 may compute a visual effect scrolling content between a first position in a rendered context to a second position based on a scroll motion provided by a user on the rendered context. Continuing this example, the camera module 242 may translate the virtual camera dolly, and thus the viewing perspective of the virtual camera, from its current position to the second position on a viewport. By way of another example, the physics engine 234 may compute a visual effect arresting the translation of surfaces beyond anchor position as discussed elsewhere herein and the camera module 242 may apply the visual effect to the virtual camera dolly to arrest the translation of the dolly beyond the anchor position as depicted in FIG. 7B.

Once a viewing perspective is generated by the camera module 242 using the virtual camera dolly, the camera module 242 may signal the rendering engine 230 to render one or more contexts for display based on the viewing perspective. In some implementations, the rendering engine 230 may signal the camera module 242 to output a viewing perspective (e.g., based on the occurrence of one or more events) for a given renderable context. In some implementations, the camera module 242 may provide the viewing perspective to the rendering engine 230 responsive to receiving data and/or instructions from the physics engine 234. In some instances, the camera module 242 may signal the surface translation engine 236 to apply the viewing perspective in a scene graph and then send the scene graph to the rendering engine 230 for rendering and display. Other variations are also possible and contemplated.

Additional structure, acts, and/or functionality of the one or more components of the client application 108, the software application 260, and/or the performance framework 116 including the rendering engine 230, the interaction engine 238, the input engine 232, the physics engine 234, the surface translation engine 236, the APIs 240, and/or the camera module 242 are further discussed elsewhere herein.

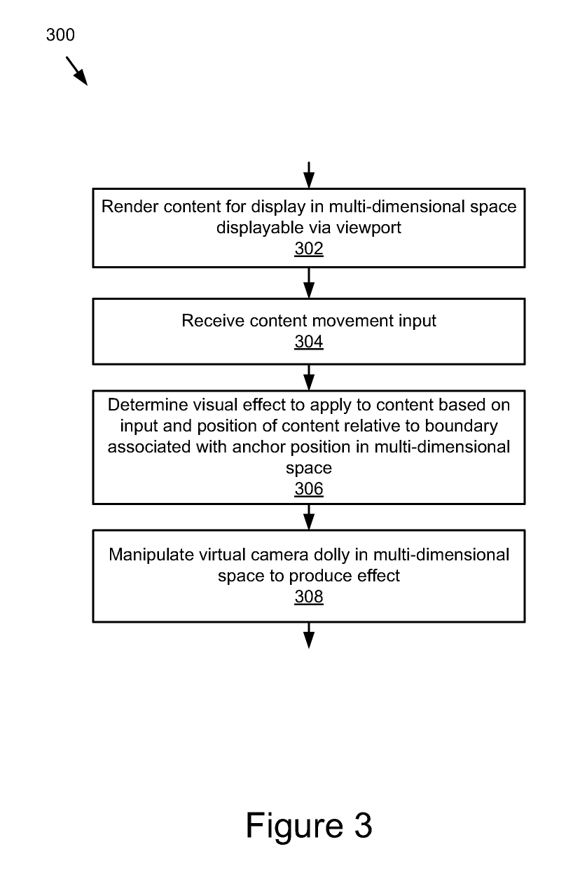

FIG. 3 is a flowchart of an example method for manipulating a virtual camera dolly in multi-dimensional space to produce a visual effect. The method 300 may begin by rendering 302 content for display in multi-dimensional space displayable via a viewport. For instance, the rendering engine 230 may render the content for display in 2D or 3D. The method 300 may receive 304 a content movement input. The input may reflect an action taken by a user relative to the rendered content. The method 300 may determine 306 a visual effect to apply to the content based on the content movement input and a position of the content relative to a boundary associated with an anchor position in the multi-dimensional space. For instance, the physics engine 234 may determine a visual effect, such as a kinematic effect or an arrestation effect, based on the content movement input and the position of the content received from the input engine 232, as discussed elsewhere herein. The method 300 may then manipulate 308 a virtual camera dolly in the multi-dimensional space to produce the effect. For instance, the camera module 242 may manipulate the virtual camera dolly based on data and/or instructions received from the physics engine 234, as discussed elsewhere herein.

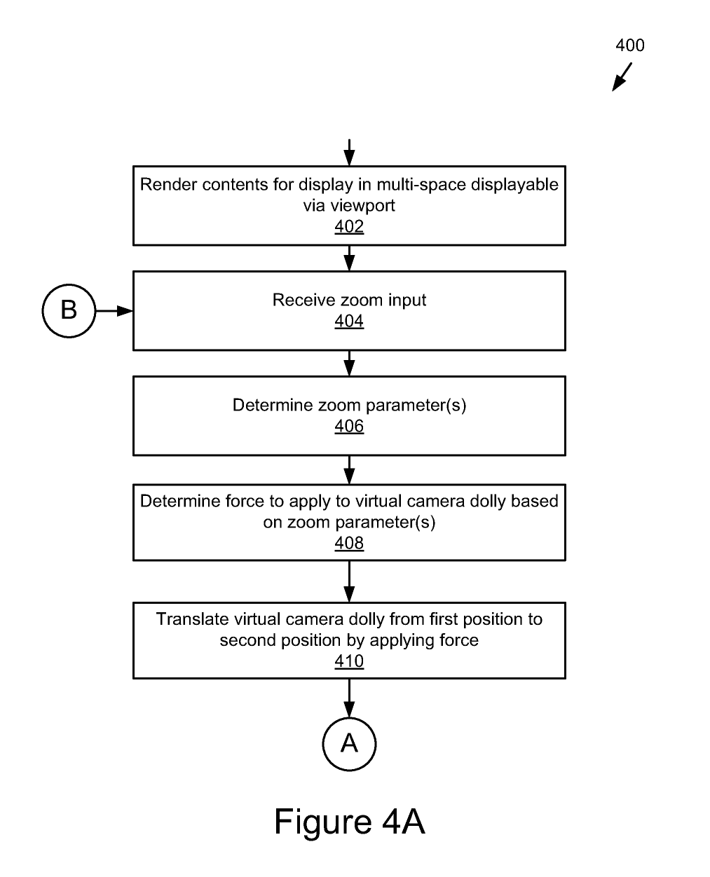

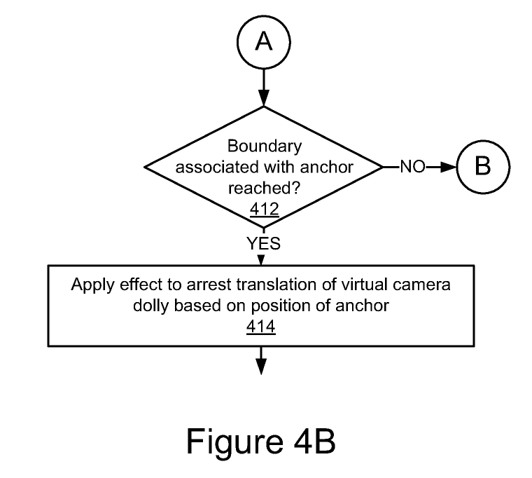

FIGS. 4A and 4B are flowcharts of an example method 400 for manipulating a virtual camera dolly in multi-dimensional space to produce a visual effect based on a zoom input. The method 400 may begin by rendering 402 contents for display in multi-dimensional space displayable via a viewport. For instance, the rendering engine 230 may render contents based on a viewing perspective generated by the camera module 242 or a scene graph provided by the surface translation engine 236, as discussed elsewhere herein. In some implementations, the contents may be 2D and/or 3D shapes, images, and/or text displayable via a web browser, although other variations are also applicable. The method 400 may receive 404 a zoom input from an input device and then determine 406 one or more zoom parameters associated with the zoom input. For example, the interaction engine 238 may receive the zoom input from an input device, send the zoom input to the input engine 232 for processing, and the input engine 232 may then process the zoom input to determine the one or more zoom parameters. The one or more zoom parameters may include, for example, a force with which the zoom input was performed, a type of zoom that was performed (zoom in or zoom out), an intensity of the zoom input, an amount of zoom associated with the zoom input, etc.

The method 400 may then determine 408 a force to apply to a virtual camera dolly based on the one or more zoom parameters. For example, the physics engine 234 may determine the force based on the one or more zoom parameters determined by the input engine 232. The method 400 may translate 410 the virtual camera dolly from a first position to a second position by applying the force determined in block 408. For instance, the camera module 242 may translate the camera dolly from the first position to the second position. In some embodiments, the method 400 may determine the force to apply to the virtual camera dolly based on a boundary associated with an anchor position specified for the contents. For instance, the physics engine 234 may determine whether the force should be a kinematic force or an arrestation force based on position of the contents relative to the boundary, as discussed elsewhere herein. The boundary may be pre-determined or dynamically determined relative to the anchor. In some instances, the boundary may be fixed at a same position as the anchor position. The boundary may specify a threshold up to which contents can be zoomed in or zoomed out as depicted, for example, in FIGS. 6A and 6B.

Returning back to operation in block 408, if the method 400 determines that the boundary associated with the anchor position is not reached, the method 400 may determine a translating force to apply to the virtual camera dolly in block 410 to translate the dolly from the first position to the second position. Translating the dolly from the first position to the second position may enable the dolly to perform a zoom-in or a zoom-out operation on the contents currently presented via the viewport. By way of example, if a user has provided a zoom-in input in block 404 on the contents, which are currently at 25% zoom level based on the virtual camera dolly's first position, then the camera dolly can move from the first position to a second position (e.g., 50% zoom) to capture a 50% zoomed image of the contents displayable via the viewport in the multi-dimensional space.

If on the other hand, the method 400 determines that the boundary associated with the anchor is reached (see block 412 in FIG. 4B), then the method 400 may determine an arrestation force to apply to the virtual camera dolly in block 414. In an example, the arrestation effect is a spring like effect (e.g., see FIG. 6B) applied to the dolly, which moves the dolly between its current position (e.g., position A) to a second position (e.g., position B) until it reaches a steady position (e.g., position C). In some embodiments, movement and/or the translation of the virtual camera dolly may be performed by the camera module 242 as described elsewhere herein.

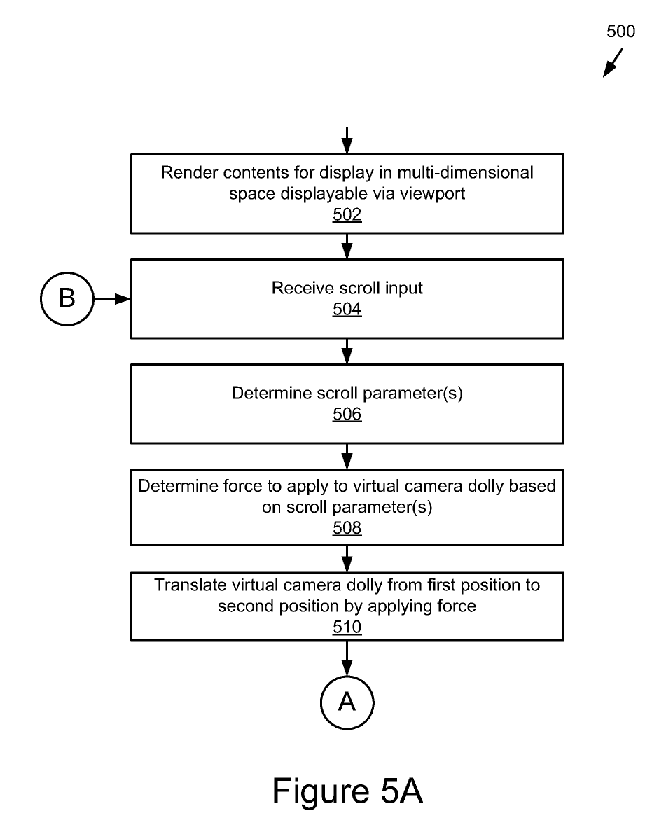

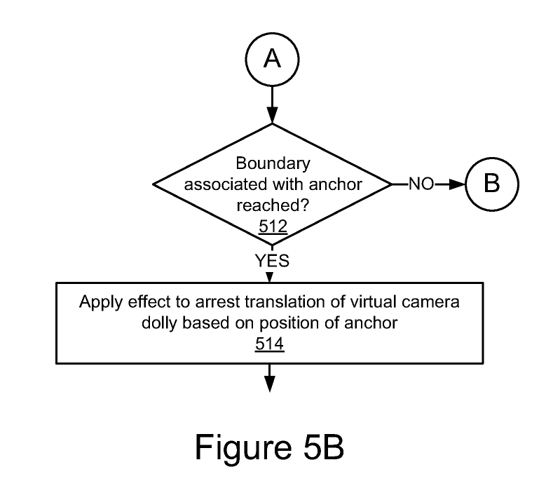

FIGS. 5A and 5B are flowcharts of an example method 500 for manipulating a virtual camera dolly in multi-dimensional space to produce a visual effect based on a scroll input. The method 500 may begin by rendering 502 contents for display in multi-dimensional space displayable via a viewport. For instance, the rendering engine 230 may render contents based on a viewing perspective generated by the camera module 242 or a scene graph provided by the surface translation engine 236. In some implementations, the contents may be 2D and/or 3D shapes, images, and/or text displayable via a web browser, although other variations are also applicable. The method 500 may receive 504 a scroll input on the contents from an input device and then determine 506 one or more scroll parameters associated with the scroll input. For example, the interaction engine 238 may receive the scroll input from a user, send the scroll input to the input engine 232 for processing, and the input engine 232 may then process the scroll input to determine the one or more scroll parameters. The one or more scroll parameters may include, for example, a direction in which the scroll was performed, a force with which the scroll input was performed, a velocity with which the scroll input was performed, an intensity of the scroll input, etc.

The method 500 may then determine 508 a force to apply to a virtual camera dolly based on the one or more scroll parameters. For example, the physics engine 234 may determine the force based on the one or more scroll parameters determined by the input engine 232. The method 500 may translate 510 the virtual camera dolly from a first position to a second position by applying the force determined in block 508. For instance, the camera module 242 may translate the camera dolly from the first position to the second position. In some embodiments, the method 500 may determine the force to apply to the virtual camera dolly based on a boundary associated with an anchor position specified for the contents. For instance, the physics engine 234 may determine whether the force should be a kinematic force or an arrestation force based on position of the contents relative to the boundary, as discussed elsewhere herein. The boundary may be pre-determined or dynamically determined relative to the anchor. In some instances, the boundary may be fixed at a same position as the anchor position. The boundary may specify the threshold for scrolling the contents in various directions (e.g., north, south, east, west, northeastern, southeastern, southwestern, and northwestern, etc.). In this example, the boundary may coincide with the peripheral edges of the contents.

Returning back to operation in block 508, if the method 500 determines that the boundary associated with the anchor position is not reached, the method 500 may determine a translating force to apply to the virtual camera dolly in block 510 to translate the dolly from the first position to the second position, thereby producing the scrolling effect. By way of example, if a user has input a downward scroll on a page, a central portion of which is viewable via the viewport, then the camera dolly can move from the first position to a second position (e.g., between the central and the end of the page) to capture contents located downstream on the page for display via the viewport in the multi-dimensional space.

If on the other hand, the method 500 determines that the boundary associated with the anchor is reached (see block 512 in FIG. 5B), then the method 500 may determine an arrestation force to apply to the virtual camera dolly in block 514. In an example, the arrestation force is a rubber band effect (e.g., see FIG. 7B) applied to the dolly, which moves the dolly between its current position (e.g., position B) to a second position (e.g., position A) until it reaches a steady position (e.g., position C). In some embodiments, movement and/or the translation of the virtual camera dolly may be performed by the camera module 242 as described elsewhere herein.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., WiFi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
rendering, using one or more computing devices, content for display via a viewport displaying a virtual multi-dimensional space;
receiving, using the one or more computing devices, a content movement input;
determining, using the one or more computing devices, a visual effect to apply to the content based on the content movement input and a position of the content relative to a boundary associated with an anchor position in the multi-dimensional space; and
manipulating, using the one or more computing devices, a virtual camera dolly to produce the visual effect, the virtual camera dolly representing a viewing perspective for viewing the content via the viewport in the multi-dimensional space.
